(19) United States
(12) Patent Application Publication
(10) Pub. No.: US 2012/0315539 A1
(43) Pub. Date: Dec. 13, 2012

(54) NANOSTRUCTURE COMPOSITE BATTERIES AND METHODS OF MAKING SAME FROM NANOSTRUCTURE COMPOSITE SHEETS

(75) Inventors: David S. Lashmore, Lebanon, NH (US); Amanda Simpson, Concord, NH (US)

(73) Assignee: Nanocomp Technologies, Inc., Concord, NH (US)

(21) Appl. No.: 13/367,572

(22) Filed: Feb. 7, 2012

Related U.S. Application Data
(63) Continuation-in-part of application No. 12/437,538, filed on May 7, 2009.
(60) Provisional application No. 61/051,249, filed on May 7, 2008.

(51) Int. Cl. H01M 4/66; H01M 10/04; H01B 1/04; H01M 4/131; B05D 5/12; B82Y 30/00

(52) U.S. Cl. 429/211; 264/105; 427/113; 29/623.2; 252/502; 977/750; 977/752

(57) ABSTRACT

A secondary battery capable of being charged after discharging is provided. The battery includes a positive electrode, made from a sheet of carbon nanotubes infiltrated with mixed metal oxides, and a negative electrode made from a sheet of carbon nanotubes with silicon or germanium particles.

### RELATED APPLICATIONS

This application is a continuation-in-part of U.S. patent application Ser. No. 12/437,538, filed May 7, 2009, which claims priority to U.S. Provisional Patent Application Ser. No. 61/051,249, filed May 7, 2008, each of which is hereby incorporated herein by reference in its entirety.

### TECHNICAL FIELD

The present invention relates to batteries, and more particularly, to secondary batteries employing sheets of non-woven carbon nanotubes.

### BACKGROUND ART

Carbon nanotubes are known to have extraordinary tensile strength, including high strain to failure and relatively high tensile modulus. Carbon nanotubes may also be highly resistant to fatigue, radiation damage, and heat. To this end, the addition of carbon nanotubes to composite materials can increase tensile strength and stiffness of the composite materials.

Within the last fifteen (15) years, as the properties of carbon nanotubes have been better understood, interests in carbon nanotubes have greatly increased within and outside of the research community. One key to making use of these properties is the synthesis of nanotubes in sufficient quantities for them to be broadly deployed. For example, large quantities of carbon nanotubes may be needed if they are to be used as high strength components of composites in macroscale structures (i.e., structures having dimensions greater than 1 cm.)

One common route to nanotube synthesis can be through the use of gas phase pyrolysis, such as that employed in connection with chemical vapor deposition. In this process, a nanotube may be formed from the surface of a catalytic nanoparticle. Specifically, the catalytic nanoparticle may be exposed to a gas mixture containing carbon compounds serving as feedstock for the generation of a nanotube from the surface of the catalyst particle.

Recently, one promising route to high-volume nanotube production has been to employ a chemical vapor deposition system that grows nanotubes from catalyst particles that “float” in the reaction gas. Such a system typically runs a mixture of reaction gases through a heated chamber within which the nanotubes may be generated from catalyst particles that have precipitated from the reaction gas. Numerous other variations may be possible, including ones where the catalyst particles may be pre-supplied.

In cases where large volumes of carbon nanotubes may be generated, however, the nanotubes may attach to the walls of a reaction chamber, resulting in the blockage of nanomaterials from exiting the chamber. Furthermore, these blockages may induce a pressure buildup in the reaction chamber, which can result in the modification of the overall reaction kinetics. A modification of the kinetics can lead to a reduction in the uniformity of the material produced.

An additional concern with nanomaterials may be that they need to be handled and processed without generating large quantities of airborne particulates, since the hazards associated with nanoscale materials are not yet well understood.

The processing of nanotubes or nanoscale materials for macroscale applications has steadily increased in recent years. The use of nanoscale materials in textile fibers and related materials has also been increasing. In the textile art, fibers that are of fixed length and that have been processed in a large mass may be referred to as staple fibers. Technology for handling staple fibers, such as flax, wool, and cotton has long been established. To make use of staple fibers in fabrics or other structural elements, the staple fibers may first be formed into bulk structures such as yarns, tows, or sheets, which then can be processed into the appropriate materials.

Accordingly, it would be desirable to provide a material that can take advantage of the characteristics and properties of carbon nanotubes, so that sheets made of carbon nanotubes can be processed for end use applications, such as batteries.

### SUMMARY OF THE INVENTION

The present invention provides, in accordance with an embodiment, a battery comprising a negative electrode including an anode current collector having at least one sheet of carbon nanotubes with semiconductor particles, a positive electrode including a cathode current collector having at least one sheet of carbon nanotubes infiltrated with mixed metal oxides, and a separator, situated between the negative electrode and positive electrode. The battery further includes a casing made from carbon nanotube composite material. In one embodiment, the composite material can comprise carbon nanotubes and polyamide, polyphenylene sulfide, polyether ether ketone, polypropylene, bispolyamide, bismaleimide, epoxies or a combination thereof

The carbon nanotube sheets can be made from single wall carbon nanotubes or multi-wall carbon nanotubes. The sheet of carbon nanotubes can have density of about 80 g/m². The sheet of carbon nanotubes can comprise substantially aligned carbon nanotubes and can further include lithium as an intercalation compound.

According to one embodiment, the anode includes semiconductor particles such as silicon or germanium particles. The silicon or germanium particles can be ultrasonically welded onto the carbon nanotubes. The cathode, in an embodiment, includes a sheet of carbon nanotubes infiltrated with a lithium mixed metal oxide comprising lithium, nickel, cobalt or mixtures thereof or alternatively infiltrated with zinc-nickel oxide. The separator can be a porous polyethylene membrane, or polyethylene membrane, or a combination thereof

The present invention also provides a method for forming an anode. The method includes generating a substantially planar body defined by a matrix of carbon nanotubes in the presence of semiconductor particles so as to allow the formation of a carbon nanotube sheet with semiconductor particles throughout the matrix of nanotubes. In an embodiment, an intercalation compound, such as lithium, can be dispersed within the sheet during the formation of the sheet or infiltrated within the sheet after the formation of the sheet. A volume of the mixture can then be deposited onto a surface so as to form a substantially planar body defined by a matrix of carbon nanotubes with semiconductor particles interdispersed within the matrix of nanotubes. In some embodiments, a cloud of carbon nanotubes is formed and semiconductor particles are introduced within the cloud to form a cloud of a mixture of carbon nanotubes and semiconductor particles. In some embodiments, the lithium can be mixed with a volatile carrier in the volume and the volatile carrier is allowed to evaporate in a hot environment so as to form a carbon nanotube composite sheet. In some embodiments, the sheet is exposed to an ultrasonic pulse train in the presence of silicon or germanium particles.

The present invention also provides a method for forming a cathode. The method includes generating a substantially planar body defined by a matrix of carbon nanotubes in the presence lithium mixed metal oxide. The lithium mixed metal oxide can comprise lithium and nickel, cobalt or mixtures thereof In one embodiment, the mixed metal oxide can be incorporated during formation of the sheet or alternatively can be sprayed onto the subsequently formed sheet. In some embodiments, a cloud of carbon nanotubes is formed and mixed metal oxide is introduced within the cloud to form a cloud of a mixture of carbon nanotubes and mixed metal oxide. A volume of the mixture can then be deposited onto a surface so as to form a substantially planar body defined by a matrix of carbon nanotubes with mixed metal within the matrix of nanotubes. In some embodiments, the lithium mixed metal oxide is mixed with a volatile carrier in the volume and the volatile carrier is allowed to evaporate in a hot environment so as to form a carbon nanotube composite sheet.

The present invention also provides a method for forming a battery. The method includes incorporating a plurality of semiconductor particles into a first a sheet of carbon nanotubes to form a negative electrode; infiltrating lithium mixed metal oxide within a second sheet of carbon nanotubes to from a positive electrode; positioning between the positive and negative electrodes a separator; and sealing the positive and negative electrodes and separator into carbon nanotube sheet impregnated with a polymer. In some embodiments, the sheet is made from aligned single wall carbon nanotubes or multi-wall carbon nanotubes.

### BRIEF DESCRIPTION OF DRAWINGS

FIG. 1 illustrates electrical properties of carbon nanotubes made in accordance with one embodiment of the present invention.

FIG. 2 illustrates resistivity versus temperature characteristics of carbon nanotubes made in accordance with one embodiment of the present invention.

FIG. 3 illustrates resistivity versus temperature characteristics of carbon nanotubes in (and out of) the presence of a magnetic field.

FIG. 4 illustrates a sheet of nanotubes in accordance with one embodiment of the present invention.

FIG. 5 illustrates an alternative embodiment of the present invention.

FIG. 6 illustrates a Chemical Vapor Deposition system for fabricating nanotubes, in accordance with one embodiment of the present invention.

FIG. 7 illustrates a system of the present invention for formation and harvesting of nanofibrous materials.

FIG. 8 illustrates a system of the present invention for formation and harvesting of nanofibrous materials.

FIG. 9 illustrates a system of the present invention for treating nanostructured sheets post formation.

FIG. 10 illustrates insertion loss from nanostructured sheets made in accordance with one embodiment of the present invention.

FIG. 11A illustrates a nanofibrous non-woven sheet generated from the system shown in FIGS. 1-2, and from which anode and cathode of a battery can be fabricated in accordance with one embodiment of the present invention.

FIG. 11B illustrates a cross section of a matrix of nanotubes in accordance with one embodiment of the present invention.

FIG. 12 illustrates prior art battery technology.

FIG. 13 illustrates a battery using sheets of carbon nanotubes in accordance with one embodiment.

FIG. 14 is an image of (a) micro-silicon particle power inserted into the carbon nanotube (CNT) conductive sheet, (b) nano-silicon particle “welded” to carbon nanotube matrix.

FIG. 15 is a graph showing the specific conductivity as a function of frequency.

FIG. 16 is a graph showing stress strain for carbon nanotube composites.

### DESCRIPTION OF SPECIFIC EMBODIMENTS

The present invention provides, in an embodiment, a composite material made from nanostructured sheets designed to promote, for instance, increased conductivity. In an embodiment, the sheet may include a substantially planar body. The planar body, in one embodiment, can be defined by a matrix of nanotubes. Matrix, as defined herein, is a lattice-like or net-like structure with opening between adjacent nanotubes. As there may exist openings between adjacent nanotubes in the matrix, a protonation agent may be applied to enhance contact between nanotubes for better conduction. To the extent desired, a plurality of composite sheets may be then layered on one another to enhance thickness of the sheet.

Presently, there exist multiple processes and variations thereof for growing nanotubes, and forming yarns, sheets or cable structures made from these nanotubes. These include: (1) Chemical Vapor Deposition (CVD), a common process that can occur at near ambient or at high pressures, and at temperatures above about 400° C., (2) Arc Discharge, a high temperature process that can give rise to tubes having a high degree of perfection, and (3) Laser ablation.

The present invention, in one embodiment, employs a CVD process or similar gas phase pyrolysis procedures known in the industry to generate the appropriate nanostructures, including carbon nanotubes. Growth temperatures for a CVD process can be comparatively low ranging, for instance, from about 400° C. to about 1350° C. Carbon nanotubes (CNTs), both single wall (SWNT) or multiwall (MWNT), may be grown, in an embodiment of the present invention, by exposing nanoscaled catalyst particles in the presence of reagent carbon-containing gases (i.e., gaseous carbon source). In particular, the nanoscaled catalyst particles may be introduced into the reagent carbon-containing gases, either by addition of existing particles or by in situ synthesis of the particles from a metal-organic precursor, or even non-metallic catalysts. Although both SWNT and MWNT may be grown, in certain instances, SWNT may be selected due to their relatively higher growth rate and tendency to form rope-like structures, which may offer advantages in handling, thermal conductivity, electronic properties, and strength.

The strength of the individual carbon nanotubes generated in connection with the present invention may be about 30 GPa or more. Strength, as should be noted, is sensitive to defects. However, the elastic modulus of the carbon nanotubes fabricated in the present invention may not be sensitive to defects and can vary from about 1 to about 1.2 TPa. Moreover, the strain to failure of these nanotubes, which generally can be a structure sensitive parameter, may range from a about 10% to a maximum of about 25% in the present invention.

Furthermore, the nanotubes of the present invention can be provided with relatively small diameter. In an embodiment of the present invention, the nanotubes fabricated in the present invention can be provided with a diameter in a range of from less than 1 nm to about 10 nm. It should be appreciated that the carbon nanotubes made in accordance with one embodiment of the present invention may be extended in length (i.e., long tubes) when compared to commercially available carbon nanotubes. In an embodiment of the present invention, the nanotubes fabricated in the present invention can be provided with a length in the millimeter (mm) range.

The nanotubes of the present invention can also be used as a conducting member to carry relatively high current similar to a Litz wire or cable. However, unlike a Litz wire or cable soldered to a connector portion, the nanotube conducting member of the present invention can exhibit relatively lower impedance in comparison. In particular, it has been observed in the present invention that the shorter the current pulses, the better the nanotube-based wire cable or ribbon would perform when compared with a copper ribbon or Litz wire. One reason for the observed better performance may be that the effective frequency content of the pulse, which can be calculated from the Fourier Transform of the waveform for current pulses that are square and short, e.g., about 100 ms to less than about 1 ms, can be very high. Specifically, individual carbon nanotubes of the present invention can serve as conducting pathways, and due to their small size, when bulk structures are made from these nanotubes, the bulk structures can contain extraordinarily large number of conducting elements, for instance, on the order of 10¹⁴/cm² or greater.

Carbon nanotubes of the present invention can also demonstrate ballistic conduction as a fundamental means of conductivity. Thus, materials made from nanotubes of the present invention can represent a significant advance over copper and other metallic conducting members under AC current conditions. However, joining this type of conducting member to an external circuit requires that essentially each nanotube be electrically or thermally contacted to avoid contact resistance at the junction.

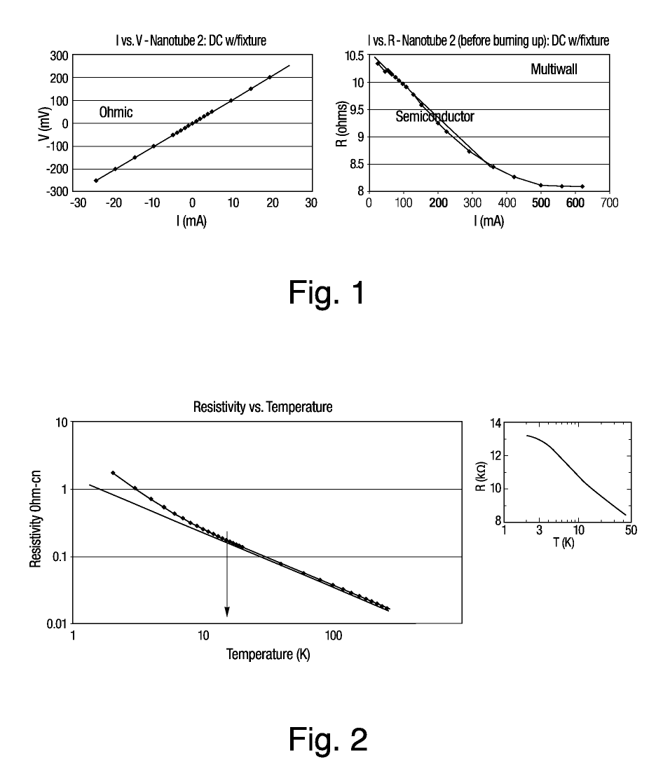

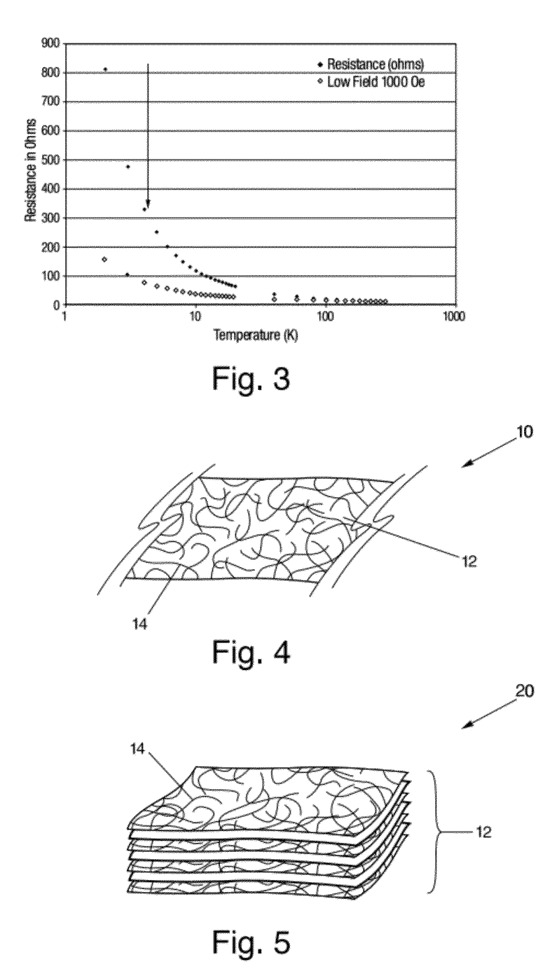

Carbon nanotubes of the present invention can exhibit certain characteristics which are shown in FIGS. 1-3. FIG. 1 illustrates the electrical properties of carbon nanotubes made in accordance with an embodiment of the present invention. FIG. 2 illustrates the resistivity of these carbon nanotubes in relation to temperature. FIG. 3 illustrates characteristics of carbon nanotube resistivity versus temperature in (and out of) the presence of a magnetic field.

It should be noted that although reference is made throughout the application to nanotubes synthesized from carbon, other compound(s), such as boron, MoS₂, or a combination thereof may be used in the synthesis of nanotubes in connection with the present invention. For instance, it should be understood that boron nanotubes may also be grown, but with different chemical precursors. In addition, it should be noted that boron may also be used to reduce resistivity in individual carbon nanotubes. Furthermore, other methods, such as plasma CVD or the like can also be used to fabricate the nanotubes of the present invention.

The present invention provides, in an embodiment, a composite material made from nanostructured composite sheets designed to increase conductivity of the carbon nanotubes within the sheet. As shown in FIG. 4, the composite material 10 may include a substantially planar body in the form of a composite sheet 12. A matrix of nanotubes 14 may define the planar body. As there may be openings between adjacent carbon nanotubes, in order to enable efficient conduction between a nanoscale environment and a traditional electrical and/or thermal circuit system, the proximity of adjacent nanotubes within the planar body may be brought closer to one another. To enhance the proximity between adjacent nanotubes, a protonation agent may be applied. In an embodiment, the composite material may be a single layer as shown in FIG. 4, or may be a plurality of layers on top of one another as shown in FIG. 5.

### System for Fabricating Sheets

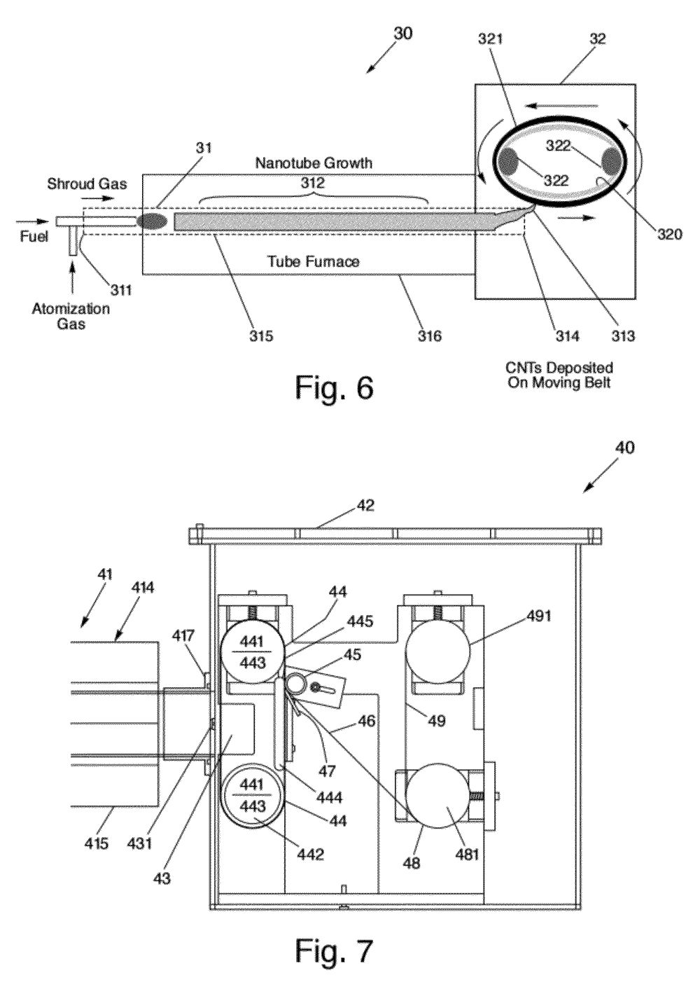

With reference now to FIG. 6, there is illustrated a system 30, similar to that disclosed in U.S. Pat. No. 7,993,620 (incorporated herein by reference), for use in the fabrication of nanotubes. System 30, in an embodiment, may be coupled to a synthesis chamber 31. The synthesis chamber 31, in general, includes an entrance end 311, into which reaction gases (i.e., gaseous carbon source) may be supplied, a hot zone 312, where synthesis of extended length nanotubes 313 may occur, and an exit end 314 from which the products of the reaction, namely the nanotubes and exhaust gases, may exit and be collected. The synthesis chamber 31, in an embodiment, may include a quartz tube 315 extending through a furnace 316. The nanotubes generated by system 30, on the other hand, may be individual single-walled nanotubes, bundles of such nanotubes, and/or intertwined single-walled nanotubes. In particular, system 30 may be used in the formation of a substantially continuous non-woven sheet generated from compacted and intermingled nanotubes and having sufficient structural integrity to be handled as a sheet.

System 30, in one embodiment of the present invention, may also include a housing 32 designed to be substantially airtight, so as to minimize the release of airborne particulates from within the synthesis chamber 31 into the environment. The housing 32 may also act to prevent oxygen from entering into the system 30 and reaching the synthesis chamber 31. In particular, the presence of oxygen within the synthesis chamber 31 can affect the integrity and compromise the production of the nanotubes 313. System 30 may also include an injector similar to those disclosed in application Ser. No. 12/140,263, incorporated herein by reference in its entirety.

System 30 may also include a moving belt 320, positioned within housing 32, designed for collecting synthesized nanotubes 313 made from a CVD process within synthesis chamber 31 of system 30. In particular, belt 320 may be used to permit nanotubes collected thereon to subsequently form a substantially continuous extensible structure 321, for instance, a non-woven sheet. Such a sheet may be generated from a matrix of compacted, substantially non-aligned, and intermingled nanotubes 313, bundles of nanotubes, or intertwined nanotubes, with sufficient structural integrity to be handled as a sheet.

To collect the fabricated nanotubes 313, belt 320 may be positioned adjacent the exit end 314 of the synthesis chamber 31 to permit the nanotubes to be deposited on to belt 320. In one embodiment, belt 320 may be positioned substantially parallel to the flow of gas from the exit end 314, as illustrated in FIG. 6. Alternatively, belt 320 may be positioned substantially perpendicular to the flow of gas from the exit end 314 and may be porous in nature to allow the flow of gas carrying the nanomaterials to pass therethrough. Belt 320 may be designed as a continuous loop, similar to a conventional conveyor belt. To that end, belt 320, in an embodiment, may be looped about opposing rotating elements 322 (e.g., rollers) and may be driven by a mechanical device, such as an electric motor. Alternatively, belt 320 may be a rigid cylinder. In one embodiment, the motor may be controlled through the use of a control system, such as a computer or microprocessor, so that tension and velocity can be optimized The collected nanotubes may then be removed manually or by any other means off the belt 320 for subsequent use.

To extent desired a pressure applicator, such as roller 45, may be employed. Referring to FIG. 7, the pressure application may be situated adjacent to belt 44, that may be positioned substantially perpendicular to the flow of gas, so as to apply a compacting force (i.e., pressure) onto the collected nanomaterials. In particular, as the nanomaterials get transported toward roller 45, the nanomaterials on belt 44 may be forced to move under and against roller 45, such that a pressure may be applied to the intermingled nanomaterials while the nanomaterials get compacted between belt 44 and roller 45 into a coherent substantially-bonded sheet 46. To enhance the pressure against the nanomaterials on belt 44, a plate 444 may be positioned behind belt 44 to provide a hard surface against which pressure from roller 45 can be applied. It should be noted that the use of roller 45 may not be necessary should the collected nanomaterials be ample in amount and sufficiently intermingled, such that an adequate number of contact sites exists to provide the necessary bonding strength to generate the sheet 46.

To disengage the sheet 46 of intermingled nanomaterials from belt 44 for subsequent removal from housing 42, a scalpel or blade 47 may be provided downstream of the roller 45 with its edge against surface 445 of belt 44. In this manner, as sheet 46 moves downstream past roller 45, blade 47 may act to lift the sheet 46 from surface 445 of belt 44. In an alternate embodiment, a blade does not have to be in use to remove the sheet 46. Rather, removal of the sheet 46 may be manually by hand or by other known methods in the art.

Additionally, a spool or roller 48 may be provided downstream of blade 47, so that the disengaged sheet 46 may subsequently be directed thereonto and wound about roller 48 for harvesting. As the sheet 46 is wound about roller 48, a plurality of layers may be formed. Of course, other mechanisms may be used, so long as the sheet 46 can be collected for removal from the housing 42 thereafter. Roller 48, like belt 44, may be driven, in an embodiment, by a mechanical drive, such as an electric motor 481, so that its axis of rotation may be substantially transverse to the direction of movement of the sheet 46.

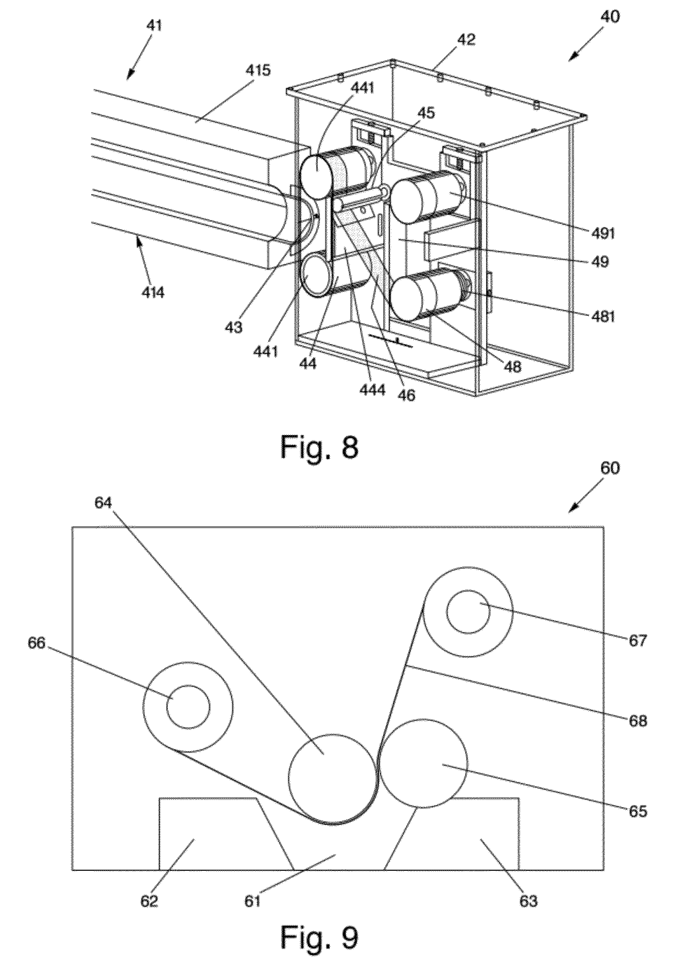

In order to minimize bonding of the sheet 46 to itself as it is being wound about roller 48, a separation material 49 (see FIG. 8) may be applied onto one side of the sheet 46 prior to the sheet 46 being wound about roller 48. The separation material 49 for use in connection with the present invention may be one of various commercially available metal sheets or polymers that can be supplied in a continuous roll 491. To that end, the separation material 49 may be pulled along with the sheet 46 onto roller 48 as sheet 46 is being wound about roller 48. It should be noted that the polymer comprising the separation material 49 may be provided in a sheet, liquid, or any other form, so long as it can be applied to one side of sheet 46. Moreover, since the intermingled nanotubes within the sheet 46 may contain catalytic nanoparticles of a ferromagnetic material, such as Fe, Co, Ni, etc., the separation material 49, in one embodiment, may be a non-magnetic material, e.g., conducting or otherwise, so as to prevent the sheet 46 from sticking strongly to the separation material 49. In an alternate embodiment, a separation material may not be necessary.

After the sheet 46 is generated, it may be left as a sheet 46 or it may be cut into smaller segments, such as strips. In an embodiment, a laser may be used to cut the sheet 46 into strips. The laser beam may, in an embodiment, be situated adjacent the housing such that the laser may be directed at the sheet 46 as it exits the housing. A computer or program may be employed to control the operation of the laser beam and also the cutting of the strip. In an alternative embodiment, any mechanical means or other means known in the art may be used to cut the sheet 46 into strips.

To the extent desired, an electrostatic field (not shown) may be employed to align the nanotubes, generated from synthesis chamber 31, approximately in a direction of belt motion. The electrostatic field may be generated, in one embodiment, by placing, for instance, two or more electrodes circumferentially about the exit end 314 of synthesis chamber 31 and applying a high voltage to the electrodes. The voltage, in an embodiment, can vary from about 10 V to about 100 kV, and preferably from about 4 kV to about 6 kV. If necessary, the electrodes may be shielded with an insulator, such as a small quartz or other suitable insulator. The presence of the electric field can cause the nanotubes moving therethrough to substantially align with the field, so as to impart an alignment of the nanotubes on moving belt.

Alternatively, the carbon nanotubes can be aligned by stretching following the synthesis of the carbon nanotube sheets as provided in co-pending U.S. application Ser. No. 12/170,092, which is incorporated herein by reference in its entirety.

System 30, as noted, can provide bulk nanomaterials of high strength in a non-woven sheet, such as sheet illustrated in FIG. 11A. The carbon nanotubes 14, in an embodiment, can be deposited in multiple distinct layers 51 to from a multilayered structure or morphology in a single CNT sheet 12, as shown in FIG. 11B. As noted above, nanofibrous non-woven sheet 110 may be made from the deposition of multiple distinct layers of either SWNT or MWNT carbon nanotubes. In an embodiment, the tensile strength of such a non-woven sheet 110 can be over 40 MPa for SWNT. Moreover, such a sheet may used with residual catalyst from the formation of the nanotubes. However, typical residuals may be less than 2 atomic percent.

By providing the nanomaterials in a non-woven sheet, the bulk nanomaterials can be easily handled and subsequently processed for end use applications, including hydrogen storage, batteries, or capacitor components, among others.

It should be appreciated that the carbon nanotubes made in accordance with an embodiment of the present invention may not require treatment with a surfactant, and may be of at least three orders of magnitude better in electrical conductivity and thermal conductivity. Moreover, the carbon nanotube sheets made in accordance with an embodiment of the present invention may include a plurality of layers. On the other hand, the carbon nanotubes in, for instance, Bucky Paper are made of relatively short nanotubes and require treatment with a surfactant. In addition, Bucky Paper is made from only one layer of nanotubes as opposed to multilayers provided with the nonwoven sheet of the present invention.

Treatment Process

To the extent desired, once a sheet 46 is generated, the sheet 46 may undergo treatment to enhance conductivity and/or productivity of the nanotubes in the sheet. If strips are generated, the strips may also undergo a treatment processes to enhance conductivity and productivity of the nanotubes in the strip.

Treatment of a sheet 46 after formation may, in an embodiment, include subjecting the sheet 46 to a protonation agent. One feature of the protonation agent may be to bring the carbon nanotubes in closer proximity with one another. By bringing the carbon nanotubes closer together, the protonation agent may act to reduce surface tension, reduce resistivity, and increase conductivity of the sheet. Examples of a protonation agent may include an acid such as hydronium ion, hydrochloric acid, hydrobromic acid, hydrofluoric acid, hydroiodic acid, carbonic acid, sulfuric acid, nitric acid, fluorosulfuric acid, chlorosulfonic acid, methane sulfonic acid, trifluoromethane sulfonic acid, oleum, an agent thereof, or a combination thereof, or other materials capable of being electrically and/or thermally conductive.

The protonation agent may be applied, in an embodiment, through the use of an apparatus 60, such as that shown in FIG. 9. The apparatus may, in an embodiment, include a plurality of rollers for guiding the sheet through the application process. As shown, a first roller 64 and second roller 65 may be situated adjacent one another with the second roller 65 being positioned downstream from roller 64. A tub 61 having a first end 62 and a second end 63 and containing the protonation agent may be situated underneath the first roller 64 and the second roller 65. The first roller may act to force the sheet through the tub 61 and onto the second roller 65. The second roller 65 may pull the sheet from the first roller 64 and may wring excess protonation agent fluid from the sheet. A third roller 66 may be positioned above the first end 62 of the tub near the first roller 64, while the fourth roller 67 may be positioned above the second end 63 of the tub near the second roller 65. Rollers 64, 65, 66, and 67 may be situated in series to allow the sheet 68 to move smoothly through the rollers. Of course, although shown in FIG. 9 as having four rollers, an apparatus for post treatment of sheets 68 may include a fewer number or a greater number of rollers. To the extent necessary, a hood may be situated in such a manner as to prevent fumes from the protonation agent to escape. In one embodiment, the apparatus 60 may include a hood such as a polypropylene hood.

Treating the sheet 68 with a protonation agent may involve positioning a bobbin or roll of sheet 68 on the third roller 66. The sheet 68 may then move downstream, passing from the third roller 66, through the first roller 64, into the tub 61 containing the protonation agent, and onto the second roller 65 and across the fourth roller 67.

In certain circumstances after treatment, the resulting sheet 68 may be acidic or basic. To bring the pH of the resulting sheet 68 to approximately neutral, a rinsing solution may be applied to the sheet 68. The rinsing solution may, in an embodiment, be applied continuously with the protonation agent or it may be applied independently of the protonation agent.

In another embodiment, treatment of the sheet 68 may further include spraying the sheet 68 with a second solution as it exits the furnace and is collected on the belt 320. The solution may contain, in an embodiment, a mixture of compounds that cover the outer surface of the nanotubes in such a manner as to enhance alignment of the carbon nanotubes and allow the carbon nanotubes to come into closer proximity with one another.

In an embodiment, the mixture of the second solution may include a solvent, a polymer, a metal, or a combination thereof The solvent used in connection with the solution of the present invention can be used to lubricate the sheet in order to gain better alignment and enhancement in the properties of the carbon nanotubes. Examples of a solvent that can be used in connection with the solution include toluene, kerosene, benzene, hexanes, any alcohol including but not limited to ethanol, methanol, butanol, isopropanol, as well as tetrahydrofuran, 1-methyl-2-pyrrolidinone, dimethyl formamide, methylene chloride, acetone or any other solvent as the present invention is not intended to be limited in this manner. In an embodiment, the solvent may be used as a carrier for a polymer, monomer, inorganic salt, or metal oxide to.

Examples of a polymer that can be used in connection with the solution include a small molecule or polymer matrix (thermoset or thermoplastic) including, but not limited to, polyurethane, polyethylene, poly(styrene butadiene), polychloroprene, poly(vinyl alcohol), poly(vinyl pyrrolidone), poly(acrylonitrile-co-butadiene-co-styrene), epoxy, polyureasilazane, bismaleimide, polyamide, polyimide, polycarbonate, or any monomer including styrene, divinyl benzene, methyl acrylate, and tert-butyl acrylate. In an embodiment, the polymer may include polymer particles, that are difficult to obtain in liquid form.

Examples of a metal that can be used in connection with the solution include a salt (any transition metal, alkali metal, or alkali earth metal salt or mixture thereof including, but not limited to, nickel hydroxide, cadmium hydroxide, nickel chloride, copper chloride, calcium zincate (CaZn₂(OH)₆)), or metal oxide (any transition metal, alkali metal, or alkali earth metal oxide or mixture thereof, including but not limited to: zinc oxide, iron oxide, silver oxide, copper oxide, manganese oxide, LiCoO₂, LiNiO₂, LiNixCol-xO₂, LiMn₂O₄). In an embodiment, the metal may include polymers or volatile solvents to create a carbon nanotube metal matrix composite. Examples of such polymers or volatile solvents include powdered forms of aluminum or its alloys, nickel, superalloys, copper, silver, tin, cobalt, iron, iron alloys, or any element that can be produced in a powdered form including complex binary and ternary alloys or even superconductors.

To disperse the solution, a spraying apparatus may be used. The spraying apparatus may be any apparatus that is commercially available. In an embodiment, at one end of the spraying apparatus, there may be a spray head, through which the solution may be sprayed onto the sheet 46. In an embodiment, the spray head may be flat, round, or any other shape so long as it can permit solution to exit therethrough. To the extent desired, the spray head may emit a solution in a continuous manner or in a preprogrammed manner.

Once the sheet 68 has been treated, the treated sheet 68 may be subject to a heat source for processing of the sheet. For example, the sheet may be subject to sintering, hot isostatic pressing, hot pressing, cold isostatic pressing so as to yield a composite sheet or the desired form of the final product.

Treatment of the composite sheet may, in another embodiment, further include infusing the composite sheet with a glassy carbon material so as to increase the structural integrity of the sheet and provide substantially low resistance coupling. Glassy carbon, in general, may be a form of carbon related to carbon nanotubes and can contain a significant amount of graphene like ribbons comprising a matrix of amorphous carbon. These ribbons include sp² bonded ribbons that can be substantially similar to the sp² bonded nanotubes. As a result, they can have relatively good thermal and electrical conductivity. Examples of precursor materials from which glassy carbon can be made include furfuryl alcohol, RESOL resin (i.e., catalyzed alkyl-phenyl formaldehyde), PVA, or liquid resin or any material known to form glassy carbon when heat treated. Of course, other commercially available glassy carbon materials or precursor materials can be used.

In accordance with an embodiment of the present invention, the carbon nanotube sheet can be chemically treated to allow for substantial alignment of the carbon nanotubes within the sheet. The carbon nanotube sheet can be further treated to insert an active compound or intercalation element, such as Lithium, as described herein.

### Battery Applications

Batteries are generally a type of electrochemical cell that contain a pair of electrodes and an electrolyte disposed between the electrodes. One of the electrodes may be referred to as a cathode, wherein an active material is reduced during discharge. The other electrode may be referred to as an anode, wherein another active material is oxidized during discharge. Secondary batteries are generally referred to as batteries capable of charging electricity after discharge.

Research has been conducted on secondary batteries, such as lithium secondary batteries, because of their high voltage and high energy density. Particular attention has been paid to an electrode material for the cathode of the secondary battery. For example, U.S. Pat. No. 4,833,048 discloses a rechargeable battery obtained by combining a disulfide compound with metal M which supplies and captures the cations (M⁺). The rechargeable battery provides an improved energy density of at least 150 Wh/kg. However, the difference between the oxidation potential and the reduction potential of the disulfide compound is very large. According to the theory of electrochemical reaction, the electron transfer of the disulfide compound proceeds extremely slowly at room temperature. Therefore, it can be difficult to obtain a rechargeable battery providing a higher current output of 1 mA/cm² or more at room temperature. The operation of a battery comprising an electrode of disulfide compound is limited to high temperatures in the range of 100° C. to 200° C., where the electron transfer can proceed faster.

Lithium based chemistries offer the promise of significant energy storage; but are limited by the weight of mobile lithium that can be stored and burdened by extra weight. One metric of power generating devices is the power to weight ratio versus the energy capacity. Since traditional batteries, as well as presently available secondary batteries, are made from relatively heavy components, the amount of energy generated may not be as efficient or ideal if lighter materials can be used.

Lithium based chemistries are almost ideal for batteries as their cell potential of 3 to 4.2V provides a very high energy current source. Safety issues with lithium batteries have for the most part been addressed by using lithium intercalation into graphite based anode as a lithium reservoir instead of pure lithium metal and by adding appropriate thermal links and pressure releases. This approach coupled with the use of shuttle compounds have minimized the safety issues associated with this chemistry. Remaining issues concern the weight of the various component parts, the potential for thermal run-away and external physical damage resulting from accidents that could expose lithium to air or water.

Existing battery technologies typically use a metal current collector coated with a compound that includes anode material, the cathode material, and current enhancing additions like graphite and a binder. Anode current collectors are typically copper, while cathode current collectors are typically aluminum, and casings are typically steel. Sometimes sintered graphite plate is used as a current collectors.

The present invention, on the other hand, provides a high power and high performance battery, for example, rechargeable or secondary battery, that employs one or more sheets of carbon nanotubes for both the cathode and the anode. The present invention also provides a high power and high performance battery for use in a variety of energy and power related applications.

The battery of the present invention, in general, includes a positive electrode, a negative electrode, a separator situated between the electrodes, and a casing. In some embodiments, the battery utilizes electrodes made from carbon nanotube sheet for use as current-collectors and can also utilize carbon nanotube composite casing. In some embodiments, the electrodes utilizes aligned carbon nanotube sheets into which an active compound or intercalation element, such as Lithium, is incorporated. In accordance with one embodiment of the present invention, the battery can by a Lithium ion type battery. Alternatively, in accordance of another embodiment of the present invention, the battery can be a nickel-zinc type battery.

The use a free-standing carbon nanotube sheets as an electrode in electrochemical applications in the present application permits the electrodes to maintain bifunctionality (i.e. role as both the active material and current collector). The potential for high temperature applications is contemplated since no binder is required to fabricate these electrodes, opening up the use in battery applications in excess of 200° C. (a temperature at which most conventional binders are unstable). The free-standing electrodes also offer a lightweight, flexible geometry for thin film batteries and alternative form factors. The physical properties of free-standing CNT sheets are important considerations for any application, but with lithium ion batteries the questions surrounding strength and conductivity are paramount. Since battery manufacturing typically utilizes roll coaters or dye cutting, strength is an important consideration for CNT electrodes, since binder and metal substrate are absent. The tensile strength of typical SWCNT sheet made in accordance with an embodiment of the present invention is about 80-100 MPa, although the synthesis and processing steps can dramatically affect this property. The Young's modulus for SWCNT sheets made in accordance with an embodiment of the present invention is in the range of about 5-10 GPa, which indicates that a large force can be applied to these materials prior to plastic deformation. Another convenient property is that the CNT sheets of the present invention can be shaped into any form factor required; they can easily be cut with conventional shears.

The electrical conductivity of purified SWCNT sheets of the present invention can be about 10⁶ S/m and can approach pure metal conductivity with appropriate doping. The temperature-dependent response for free-standing electrodes of the present invention also can have attractive electrical properties, including a conductivity response that shows less than about 3% variation in conductivity over the range of about 100-400 K. The electronic transport in free-standing SWCNT electrodes made in accordance with an embodiment of the present invention can be attributed to predominant metallic conduction interrupted by tunneling barriers due to tube-tube interactions, as well as contributions from phonon scattering and variable range hopping.

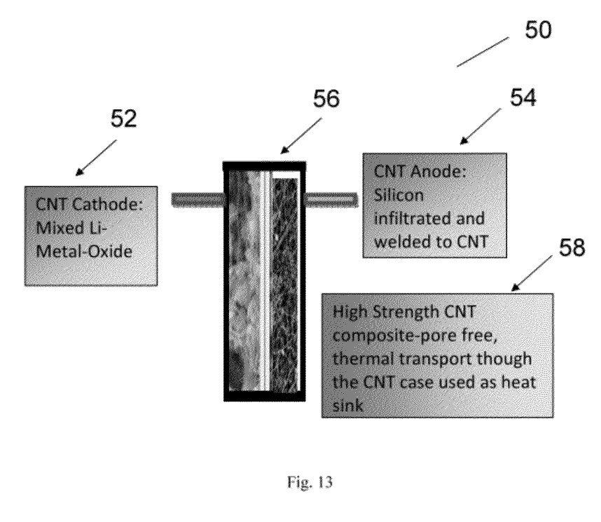

The major structural elements of the battery of the present invention include the (1) anode current collectors, (2) cathode current collectors and (3) the structural casing, all of which can be made from CNT sheets and or CNT composite sheets. FIG. 13 illustrates one embodiment of the battery. Battery 50, as shown, includes a carbon nanotube cathode 52, a carbon nanotube anode 54, a separator 56 between the cathode and the anode and a casing 58. The battery 50 can also have an electrolyte material. During charging of the battery 50, ions (for instance Lithium ions) move from the positive electrode (cathode) to the negative electrode (anode), while during discharging the ions move from the negative electrode to the positive electrode.

The carbon nanotubes composition of the present invention can also be useful in minimizing the weight of the battery as compared to existing batteries and in increasing the energy to weight and/or energy to volume ratio of the battery of the present invention.

The fabrication of stand-alone CNT electrodes can eliminate the need for metal foil substrates and increase capacity and rate capability. The free-standing CNT electrodes can store lithium and also support ultra high capacity semiconductor particles, like silicon and germanium, which may significantly increase the usable anode specific capacity (Ah/kg) in a battery.

The battery of the present invention has the advantage of not having heavy materials such as the aluminum anode and copper cathode or binders and conductive fillers. The carbon nanotube composition of the battery of the present invention can also provide for a high fracture toughness. In addition, the carbon nanotube battery of the invention can insure against thermal hot spots that have the potential for initiating run-away.

The anode and the cathode may be formed, in one embodiment, from at least one sheet of carbon nanotubes. The sheet of carbon nanotubes may be fabricated by a CVD process using system 30 shown in FIG. 6. The nanotubes generated in the gas phase using a floating catalyst CVD process can form a cloud of nanotubes that can be deposited on a rotating drum. Compounds such as nickel, zinc, nickel-zinc alloys, lithium, lithium mixed metal oxides, nickel-zinc oxides, and the like or combinations thereof, can be added to form a cloud of nanotubes with the compounds that can be deposited on a rotating drum. The drum may translate in front of the furnace exit to create a wide mat defined by a plurality of layers of carbon nanotubes within a single sheet (see FIG. 11b). Referring to FIG. 5, a plurality of layers 12 of nanotubes 14 may be deposited to build a non-woven sheet 20 to a desired density. In an embodiment, the density of the non-woven sheet is about 1 mg/cm². In some embodiments, the density of each non-woven sheet can be controlled within a wide range, for instance from about 0.1 mg/cm² to about 5 mg/cm². An example of such a non-woven sheet is shown in FIG. 11a as item 110. Each sheet, in one embodiment, can be made with varying thickness and/or numbers of layers of carbon nanotubes 14. In some embodiments, a plurality of sheets may be necessary to build a carbon nanotube mat having a density of about 80 g/m². For example, a plurality of sheets can be layered on top of one another to provide for the desired carbon nanotube density. To the extent desired, the sheet may have or may not have a protonation agent.

### Cathode

The cathode, in an embodiment, may be made from, for example, from one or more sheets of aligned carbon nanotubes infiltrated with mixed metal oxides. In accordance to an embodiment, the mixed metal oxide can be a nickel-zinc oxide, a nickel-cobalt oxide, a lithium metal oxide or any other similar compound being utilized for generation of an electrical current. For example, the carbon nanotube sheet can be infiltrated with nano-scaled iron-lithium-phosphate, lithium-nickel-oxides, lithium-cobalt-nickel-oxides, lithium-cobalt-oxides, zinc-nickel oxides or combination thereof. Other substitutions may include lithium compounded with sulfur (for oxygen), sulfates, borates and silicates. Alternatively, the batteries of the present invention can be zinc air based, sodium based or lead acid based. It should be noted that although reference is made to sheets of aligned carbon nanotubes, sheets of non-aligned carbon nanotubes may also be used.

The mixed metal oxides can be incorporated within the carbon nanotube sheets during the construction of the carbon nanotube sheets for use as a cathode. In some embodiments, mixed metal oxide can be added during the nanotube growth process. For example, mixed metal oxide can be dispersed with the cloud of nanotubes during the nanotube growth process using any known methods. In an alternated embodiments, mixed metal oxide can be added or deposited after formation of the carbon nanotube sheet using known methods. For instance, mixed metal oxide can be dispersed in a volatile carrier, such as acetone, isopropanol, methanol, ethanol and the like, and spayed onto the carbon nanotube sheet. The carrier can be evaporated from the sheet by heating the sheet to form a carbon nanotube particulate composite material.

### Anode

The anode of the battery of the present invention, can include one or more sheets of carbon nanotubes into which graphite particles, silicon particles, germanium particles or combination thereof are incorporated. The anode can be formed from aligned CNT sheets having a lithium intercalation compound or a zinc-nickel alloy placed into the structure either by adding lithium or zinc-nickel powder during the growth process as with the cathode or by spraying pre-formed carbon nanotube sheets. It should be noted that although reference is made to sheets of aligned carbon nanotubes, sheets of non-aligned carbon nanotubes may also be used.

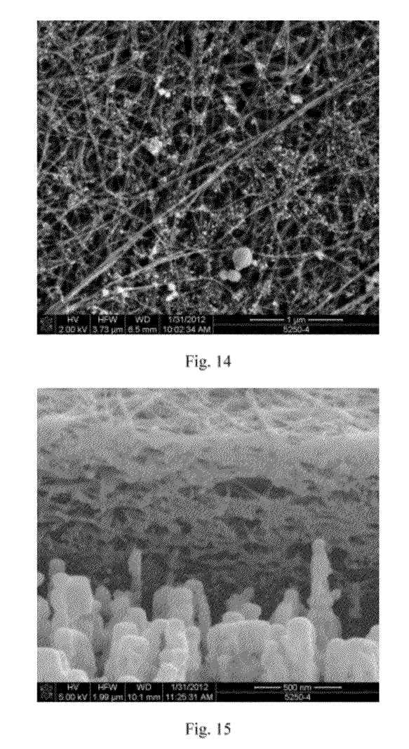

Silicon or germanium particles, in an embodiment, can be coated onto the sheets of carbon nanotube using a Chemical Vapor Deposition process. For instance, referring to FIGS. 14-15, semiconductor powder, such as silicon powder or germanium powder can be incorporated into the carbon nanotube sheets. Alternatively, semiconductor powder, such as silicon powder or germanium powder, can be welded to the carbon nanotube sheet to form the negative current collector or anode. In some embodiments, particles of silicon can be dispersed in a solvent or carrier, such as acetone, ethanol, methanol and the like, and welded to the CNT sheets by powerful ultrasonic pulse. In some embodiments, the particles of silicon or germanium are added to the carbon nanotubes using high energy welding, or similar processes known in the art, so that the silicon particles become integral with the carbon nanotubes. For instance, the particles of silicon or germanium may be positioned on top of one or more carbon nanotubes or at the surface of one or more carbon nanotubes. Alternatively, the silicon particles can be attached to the surface of the carbon nanotubes by any other suitable methods known in the art.

In some embodiments, the particles of silicon or germanium are in the micrometer or nanometer ranges. In some embodiments, the silicon or germanium particles are 100 nm or less.

By providing carbon nanotube sheets having silicon or germanium nano-particles inserted therein, it may not be necessary to add binders or conductive additives to the anode. In addition, thermal stability can be improved to the point where thermal sensors and venting valves can be potentially be eliminated.

An important impact of using an electrode made from a free standing sheet of carbon nanotubes is that the usable capacity can be increased by removing the inactive copper foil. Removal of the copper substrate has additional benefits including an increased depth of discharge and the ability to maintain a near-zero volt state of charge. It is well documented that prolonged cycling below 2.5 V leads to oxidation of the copper substrate.

In addition, it has been observed that the sheet of carbon nanotubes having silicon or germanium particles, produced by the method employed by the present invention, have a energy density up than three times higher than the energy density of commercial graphite anodes (see Table 1).

In one embodiment, 0.5 mg of nanosilicon particles were dispersed in 250 ml of acetone. Individual carbon nanotube sheets were placed into a metal holder as that they are suspended in solution at a distance of 0.25 to 0.50 inches from the ultrasonic horn (Ultrasonicator VC600, Sonics & Materials, Newton). The ultrasonic horn was set to the following settings Duty Cycle: 2 and Micro-tip limit: 2.3. The duty cycle dictated the percentage of time that pulses were delivered to the samples. The amplitude, which is measured in microns is defined as the up and down distance (excursion) that the probe tip travels. The amplitude set point was based upon the diameter of the probe and dictated the amount of energy that will be transmitted into the liquid. A timer was set to a desired value and ultrasonication was started. The ultrasonic horn was maintained in the center of the beaker to ensure that power was delivered to the samples evenly.

TABLE 1
Comparison of carbon nanotube with commercial anode in terms
of weight volumetric and fade

| | Commercial | PSI/NCTI |
|---|---|---|
| | Graphite Anode | Si/SWNT Anode |
| Energy density | 350 | 1500 |
| (mAh/g) | | |
| Energy density | 525 | 2250 |
| (mAh/cc) | | |
| Capacity Fade - | 0.2% | 2% |
| percent cycle | | |
| Current | 9 micron copper | SWNT |
| collector | | |

Commercially available graphite anode with copper current collector has an energy density of 350 mAh/g while anode having silicon vapor deposited on a SWNT current collector sheet can provide an energy density of about 1500 mAh/g or more. In addition to the above, it has been determined that the sheet of carbon nanotubes of the present invention has a capacitance ten times higher or more as compared to commercially available anodes.

### Separator

The positive and negative electrode can be designed, in one embodiment, to be separated by a separator. For instance, the separator can be a membrane, such as a porous and hydrophilic membrane. In some embodiments, the separator can be a polypropylene and/or polyethylene electrolytic membrane. It should be appreciated that other thin separators/membranes may alternatively be placed between the electrodes, so long as the membrane permits diffusion of the electrolyte therethrough. In an embodiment, the membrane may be a CELGARD™ porous polyethylene membrane, or polyethylene membrane, or a combination thereof, or any other membrane capable of being used with alkaline batteries.

Any suitable electrolyte solution can be used. Exemplary electrolytes include, without limitation, aqueous solutions of KOH, HNO₃, HCl, tetraethylammonium bis(oxaloato)borate (TEABOB), tetraethylammonium tetrafluoroborate (TEABF₄), or triethylmethylammonium tetraflouraborate dissolved in acetonitrile

### Casing

In some embodiments, the battery casing is made from carbon nanotube polymeric composite. The battery casing can be formed from a pre-impregnated CNT sheet. These sheets can be impregnated with a wide variety of polymeric matrices such as toughened epoxy, bismaliamide, polypropylene, polyethylene, PPS, PEEK (polyether ether ketone), PTFE and the like. In some embodiments, the sheet can include a carbon nanotube content from about 20 to about 50%. The density of the resultant composite can be less than 2 grams per cc compared with more than 7.8 g/cc for the standard steel casings.

The busses to the sheet of carbon nanotubes can either be riveted or spot welded. The latter being possible because the edges of the sheet of carbon nanotubes can, in an embodiment, be preliminarily electroplated with nickel.

These battery casings can be massed produced separately or the battery material (anode, cathode, separators, inlet values, outlet valves) can be encapsulated with the pre-impregnated during the manufacturing process. The casing can be used to thermally seal the battery anode, separator and cathode in one step. Alternatively, thermally setting matrix materials can be used to completely seal the battery following assembly. If desired safety pressure release values can be co-sealed into the structure during assembly.

Such composite material have, in some embodiments, a breaking strength higher than steel and are lighter by a factor of about 4. In addition, such carbon nanotube composite materials provide for a casing with high fracture toughness. It should be noted that casings made from carbon nanotube composites have the advantage to be much stronger and have a higher fracture toughness than conventional casings made from steel, and can be used as battery structural elements to mitigate crash damage.

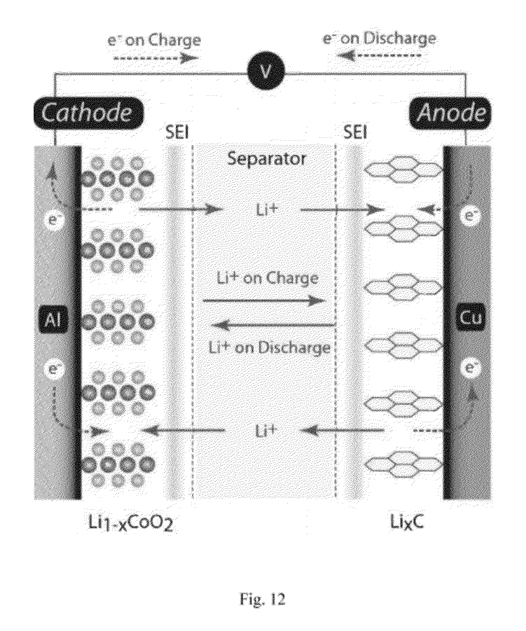

A comparison between existing technology and the battery according to one embodiment of the present invention is shown in FIGS.12-13. In some embodiments, the anode is a mat having a plurality of carbon nanotube sheets on top of one another and comprising particles of silicon infiltrated and welded to the carbon nanotubes (FIG. 14).

FIG. 15 illustrates the specific conductivity as function of frequency were measured for a copper collector and for a carbon nanotube collector.

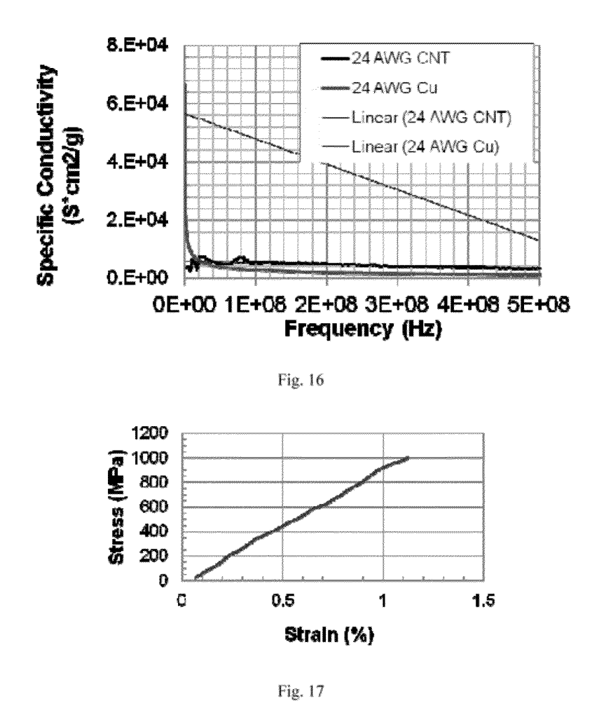

FIG. 16 illustrates the stress strain curve of a 60% carbon nanotube epoxy composite. As shown, the carbon composite material has a breaking stress of 1 Gpa.

Battery pack

In accordance with some embodiments of the present invention, the battery may be designed to optimize the energy density and/or power. It is possible to design the battery to store a desired amount of energy by increasing the number of cells in a battery pack. Accordingly, the battery can, in an embodiment, be optimized to include two or more cells, each cell having a desired geometry and dimension. For instance, the cells can be cylindrical (spiral-wound) or prismatic. Cells can be assembled into a module or into a battery pack. Cells or modules can be packaged in casings made from carbon nanotube composites, as described herein, which have the advantage to be much stronger and have a higher fracture toughness than steel, and can mitigate crash damage.

It should be appreciated that the carbon nanotube composite material of the casing can act as a heat sink. Therefore, the design of the battery of the present invention having the components as set forth can allow the battery to operate without additional protection, such as pressure sensor, temperature sensor, pressure release valve or safety vents.

### Advantages and Applications

One of the shortcomings of the metal hydride type battery is the degradation of electrode integrity in the course of multiple charging-discharging of the battery. This is because accompanying the hydriding phase change there can also be a change in the lattice contacts that can result in an expansion leading to cracking in the alloy. Such alloy typically can withstand about 300 to 500 cycles until the battery starts to loose performance.

On the other hand, when using nanostructure materials fabricated by the method of the present invention, the number of cycles that a battery can withstand can be increased. In particular, a battery utilizing a sheet of carbon nanotubes made in accordance with an embodiment of the present invention can minimize this type of degradation, and therefore can withstand an unlimited number of charge-discharge cycles.

It should be appreciated that the sheet of carbon nanotubes have the advantage not only to be able to store as much energy than lithium ion batteries but also not degrade with charge/discharge cycle. In addition, the sheet of carbon nanotubes can offer a substantially high surface area, so that double layer charging can be accommodated, so as to hold tremendous energy that can be returned on demand if very high but short peak power is required of the battery. This behavior is in strong distinction between the battery of the present invention and other commercially available secondary batteries.

The battery of the present invention, having the components set forth above, including sheets of conductive carbon nanotubes, has applications as a secondary battery. Secondary batteries are generally batteries that are capable of charging electricity after discharge. The design of the battery of the present invention can also permit the battery to be discharged in two steps. In particular, the first discharge of the battery can produce relatively high power, while the second discharge can produce relatively high energy.

Carbon nanotubes of the present invention possess a variety of useful properties including a high aspect ratio, channels for lithium ion intercalation, improved conductivity, both electrical and thermal, and increased capacity. It should be noted that cathodes having SWCNT or MWCNT sheets of the present invention, as well as anodes having SWCNT or MWCNT sheets of the present invention, can show an improvement in electrical and thermal conductivity and capacity. In addition, the cathodes and anodes made using the sheets of the present invention can show a reduction in weight. Moreover, the use of carbon nanotube sheets of the present invention can show an improvement in the power to weight ratios versus the energy capacity.

It should be noted that the design of the battery can be optimized to reduce battery mass and volume and to allow for use in for example, electrical vehicles. There is currently a worldwide pursuit for sustainable energy systems that will simultaneously reduce dependence on fossil fuels and greenhouse gas emissions. Underlying these initiatives are strategies towards developing more sustainable transportation (e.g. electric vehicles) and the ability to increase renewable energy consumption from solar and wind technologies. Due to the intermittency of such production and consumption requirements, these directions require significant electrical storage capabilities that are expected to be realized effectively only with advanced batteries. Lithium ion technology has emerged as the premier battery chemistry due to the increased energy density over other rechargeable technologies. However, ongoing technology demands necessitate higher energy densities which can reduce battery mass and volume characteristics in portable applications like electrical vehicles, mobile communications, and mobile grid storage. Advancements in lithium ion batteries will directly support both of ARPA-E mission areas since battery-enabled electric vehicles will significantly reduce the use of foreign energy sources and greenhouse gas emissions.

### Other Applications

The systems and methods of the present invention can provide bulk nanomaterials of high strength, lower or similar weight, in a composite sheet. By providing the nanomaterials in a composite sheet, the bulk nanomaterials can be easily handled and subsequently processed for end use applications, including (i) structural systems, such as fabrics, armor, composite reinforcements, antennas, electrical or thermal conductors, heaters, and electrodes, (ii) mechanical structural elements, such as plates and I-beams, and (iii) cabling or ropes. Other applications can include hydrogen storage, or capacitor components.

The scale-up and commercialization of the aforementioned technology depends upon the ability to produce large quantities of materials of sufficient quality at a price which is comparable to current lithium ion battery carbons and substrates. Large sheets of high quality SWCNTS, produced in accordance with the methods of the present invention, provide a strong, lightweight and electro-thermally conductive material from which the battery can be made.

Moreover, the composite sheet may be incorporated into composite structures for additional end use applications, such as sporting goods products, helmets, antenna, morphing applications, aerospace, lightning protection flame proofing, etc. Composite sheets may further be nickel free, meaning they may be less toxic than standard products. Additionally, composite sheets may be repairable to eliminate the need to replace the composite sheets entirely or in part. In one embodiment, a composite material may be formed by impregnating the composite sheet with a matrix precursor, such as Krayton, vinyl ester, Polyphenylene Sulfide (PPS), Polyether ether ketone (PEEK), bispolyamide, BMI (bismaleimide), epoxies, or polyamides, and subsequently allowing the matrix to polymerize or thermally cure.

Composite sheets of carbon nanotubes made from the present invention can have a wide variety of applications. Examples of specific applications include electromagnetic interference shielding (EMI shielding) which may either absorb, reflect, or transmit electromagnetic waves. Shielding may be beneficial to prevent interference from surrounding equipment and may be found in stereo systems, telephones, mobile phones, televisions, medical devices, computers, and many other appliances. For these and similar applications, it may be important that the glassy carbon precursor be provided in a substantially thin layer, so that infiltration into the carbon nanotube sheet can be minimized to prevent degradation to the properties of the sheet.

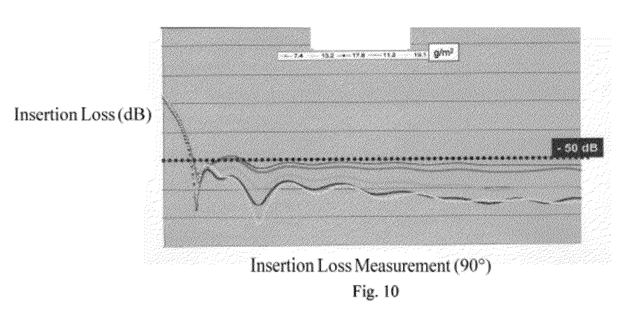

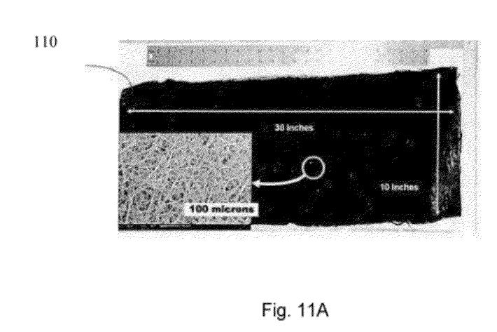

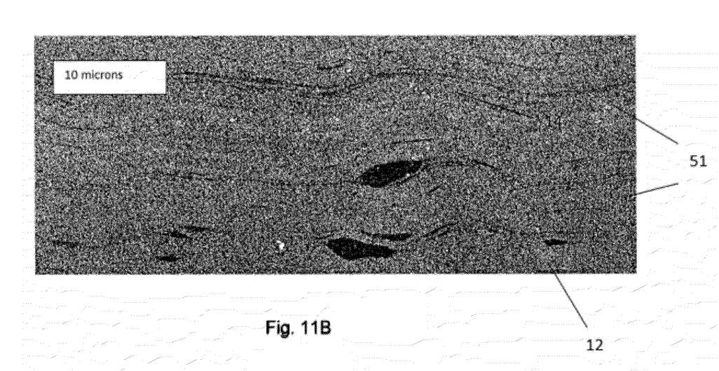

EMI shielding may further be useful in minimizing insertion loss from sheets of carbon nanotubes. Insertion loss represents the difference in power reception prior to and after the use of a composite sheet. As illustrated in FIG. 10, there is an almost immediate drop in power reception followed by a stabilization.

Composite sheets of carbon nanotubes can have additional applications, such as utilizing the resulting assembly in the absorption of radar signal (EMI shielding) or to provide other desirable properties, such as lighting protection, heat sinks, or actuators. For such applications, it may not be critical if the bonding agent penetrates the carbon nanotube sheet. Accordingly, the glassy carbon material can be coated with less care than for that carried out in capacitor, battery or fuel cell applications. In one embodiment, the substrate for applications in this example can be a graphite epoxy, e-glass epoxy, or combinations with other types of matrices.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. A battery comprising:
a negative electrode including an anode current collector having at least one sheet of carbon nanotubes and semiconductor particles interdispersed within the sheet;
a positive electrode including a cathode current collector having at least one sheet of carbon nanotubes infiltrated with mixed metal oxides; and
a separator, situated between the negative electrode and positive electrode.

2. A battery of claim 1, wherein the sheets are made from single wall carbon nanotubes.

3. A battery of claim 1, wherein the sheets are made from multi-wall carbon nanotubes.

4. A battery of claim 1, wherein the semiconductor particles are silicon or germanium particles.

5. A battery of claim 1, wherein the semiconductor particles are welded on the carbon nanotubes.

6. A battery of claim 1, wherein the positive electrode is made from a sheet of carbon nanotubes infiltrated with a lithium mixed metal oxide comprising lithium, and nickel, zinc, cobalt or mixtures thereof

7. A battery of claim 1, further including a casing made from carbon nanotube composite material.

8. A battery of claim 7, wherein the composite material includes polyamide, polyphenylene sulfide, polyether ether ketone, polypropylene, bispolyamide, bismaleimide, epoxies and combination thereof

9. A battery of claim 1, wherein the separator is a porous polyethylene membrane, or polyethylene membrane, or a combination thereof

10. A battery of claim 1, wherein the sheets of carbon nanotubes has density of about 80 g/m².

11. A battery of claim 1, wherein the battery is a prismatic battery.

12. A battery of claim 1, wherein the sheet of carbon nanotubes comprises substantially aligned carbon nanotubes.

13. A battery of claim 1, wherein the sheet of carbon nanotubes further comprises lithium as an intercalation compound.

14. A battery of claim 9, wherein the separator is soaked in electrolyte solution.

15. A method for forming an anode for use in a battery, the method comprising:
forming a cloud of carbon nanotubes;
introducing within the cloud, semiconductor particles to form a cloud of a mixture of carbon nanotubes and semiconductor particles; and
depositing a volume of the mixture onto a surface so as to form a substantially planar body defined by a matrix of carbon nanotubes with semiconductor particles interdispersed within the matrix.

16. A method of claim 15 wherein the step of generating is in presence of lithium.

17. A method of claim 15, further comprising mixing the lithium with a volatile carrier and allowing the volatile carrier to evaporate so as to from a carbon nanotube composite sheet.

18. A method of claim 15, wherein in the step dispersing the semiconductor particles, the particles are silicon or germanium particles.

19. A method for forming an anode for use in a battery, the method comprising:
providing substantially planar body defined by a matrix of carbon nanotubes;
dispersing semiconductor particles within the matrix semiconductor particles using an ultrasonic pulse train.

20. A method for forming a cathode for use in a battery, the method comprising:
forming a cloud of carbon nanotubes;
introducing within the cloud, lithium mixed metal oxide to form a cloud a mixture of carbon nanotubes and lithium mixed metal oxide; and
depositing a volume of the mixture onto a moving surface so as to form a substantially planar body defined by a matrix of carbon nanotubes with lithium mixed metal oxide interdispersed within the matrix.

21. A method of claim 20, further comprising mixing the lithium mixed metal oxide with a volatile carrier and allowing the volatile carrier to evaporate so as to from a carbon nanotube composite sheet.

22. A method of claim 20 wherein in the step of introducing, the lithium mixed metal oxide comprises lithium and nickel, cobalt or mixtures thereof

23. A method of claim 22 wherein in the step of introducing, the lithium mixed metal oxide comprises lithium and nickel, cobalt or mixtures thereof

24. A method for forming an anode for use in a battery, the method comprising:
providing substantially planar body defined by a matrix of carbon nanotubes;
spraying lithium mixed metal oxide onto the matrix.

25. A method manufacturing a battery, the method comprising:
incorporating a plurality of semiconductor particles into a first a sheet of carbon nanotubes to form a negative electrode;
infiltrating lithium mixed metal oxide within a second sheet of carbon nanotubes to from a positive electrode;
positioning between the positive and negative electrodes a separator; and
sealing the positive and negative electrodes and separator with a casing of carbon nanotube sheet.

25. A method of claim 24, wherein, in the step of incorporating, the semiconductor particles are welded onto the carbon nanotubes.

26. A method of claim 24, wherein in the step of incorporating, the semiconductor particles are silicon or germanium particles.

27. A method of claim 24, wherein in the step of infiltrating, the lithium mixed metal oxide comprises lithium, and nickel, cobalt or mixtures thereof

28. A method of claim 24, wherein in the step of sealing, the casing includes carbon nanotube composite material.

29. A method of claim 29, wherein in the step of sealing, the composite material comprises polyamide, polyphenylene sulfide, polyether ether ketone, polypropylene, bispolyamide, bismaleimide, epoxies and combination thereof

30. A method of claim 24, wherein in the step of positioning, the separator is a porous polyethylene membrane, or polyethylene membrane, or a combination thereof

31. An anode for use in a battery, comprising:
at least one sheet of carbon nanotubes; and
a plurality semiconductor particles interdispersed within the sheet.

32. A cathode for use in a battery, comprising:
at least one sheet of carbon nanotubes; and
mixed metal oxide infiltrated within the sheet.
